(19) United States
(12) Patent Application Publication
(10) Pub. No.: US 2026/0269661 A1
(43) Pub. Date: Sep. 10, 2026

(54) STATOR, ROTARY ELECTRICAL MACHINE, AND STATOR PRODUCTION METHOD

(71) Applicant: MITSUBISHI HEAVY INDUSTRIES ENGINE & TURBOCHARGER, LTD., Sagamihara-shi, Kanagawa (JP)

(72) Inventors: Wataru YAMADA, Tokyo (JP); Takehiko IMAI, Tokyo (JP); Makoto OGAWA, Sagamihara-shi (JP); Shota YOSHIKAWA, Sagamihara-shi (JP); Yuki YAKUWA, Tokyo (JP); Naomichi SHIBATA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/166,577

(22) PCT Filed: Apr. 11, 2023
(86) PCT No.: PCT/JP2023/014690

§ 371 Date: Sep. 18, 2025

(51) Int. Cl. H02K 1/14; H02K 3/34; H02K 15/022; H02K 15/106; H02K 15/121

(52) U.S. Cl. CPC H02K 1/146; H02K 3/345; H02K 15/022; H02K 15/106; H02K 15/121

(57) ABSTRACT

This stator comprises: a stator core that has a yoke which extends in a circumferential direction and a plurality of teeth which are disposed at intervals in the circumferential direction on the inner circumferential side of the yoke; a stator coil that is disposed between two adjacent teeth; an insulation sheet that is disposed between two adjacent teeth and that is interposed between the stator core and the stator coil; and an insulation member that is disposed between two adjacent teeth and that is disposed radially inward of the stator coil. The insulation sheet includes a first interposed part that is interposed between the insulation member and one of two adjacent teeth, and a second interposed part that is interposed between the insulation member and the other of the two adjacent teeth.

### TECHNICAL FIELD

The present disclosure relates to a stator, a rotary electrical machine, and a stator production method

### BACKGROUND ART

In a stator that configures a rotary electrical machine such as an electric motor or a generator, it has conventionally been required to ensure insulation properties between a stator core and a stator coil. For example, in a stator disclosed in PTL 1, an insulating paper sheet is disposed on an inner peripheral side of the stator (refer to FIG. 47 of PTL 1).

### CITATION LIST

### Patent Literature

[PTL 1] Japanese U.S. Pat. No. 5,011,152

### SUMMARY OF INVENTION

### Technical Problem

As the voltage in the stator coil increases, the risk of conduction between a stator core and the stator coil increases.

An object of the present disclosure is to provide a stator, a rotary electrical machine, and a stator production method, in which insulation properties are improved.

### Solution to Problem

A stator according to at least one embodiment of the present disclosure includes:
a stator core that includes a yoke extending in a circumferential direction and a plurality of teeth disposed on an inner peripheral side of the yoke at intervals in the circumferential direction;
a stator coil disposed between two adjacent teeth;
an insulation sheet disposed between the two adjacent teeth and interposed between the stator core and the stator coil; and
an insulation member disposed between the two adjacent teeth and disposed inside the stator coil in a radial direction,
wherein the insulation sheet includes
   a first interposed portion that is interposed between one of the two adjacent teeth and the insulation member, and
   a second interposed portion that is interposed between the other of the two adjacent teeth and the insulation member.

A rotary electrical machine according to one embodiment of the present disclosure includes:
the stator;
a rotary shaft that is provided inside the stator in the radial direction; and
a rotor that is provided in the rotary shaft and faces the stator in the radial direction.

A stator production method according to one embodiment of the present disclosure includes:
an insulation sheet disposition step of disposing an insulation sheet in a slot space which is a space between two adjacent teeth included in a stator core;
a stator coil disposition step of disposing a stator coil in the teeth after executing the insulation sheet disposition step; and
an insulation member insertion step of inserting an insulation member into the slot space after executing the stator coil disposition step.

### Advantageous Effects of Invention

According to the present disclosure, there are provided a stator, a rotary electrical machine, and a stator production method, in which insulation properties are improved.

### BRIEF DESCRIPTION OF DRAWINGS

FIG. 1 is a schematic sectional view of an electric compressor device according to one embodiment.

FIG. 2 is a schematic cross-sectional view of a stator according to one embodiment.

FIG. 3A is a schematic cross-sectional view of a stator according to one embodiment (first example).

FIG. 3B is a schematic cross-sectional view of a stator according to one embodiment (second example).

FIG. 3C is a schematic cross-sectional view of a stator according to one embodiment (third example).

FIG. 4 is a schematic diagram of an insulation member according to one embodiment.

FIG. 5 is a flowchart illustrating a stator production method according to one embodiment.

FIG. 6 is a schematic diagram illustrating a production process of the stator according to one embodiment.

FIG. 7 is a schematic diagram illustrating the production process of the stator, which follows FIG. 6.

FIG. 8 is a schematic diagram illustrating the production process of the stator, which follows FIG. 7.

FIG. 9 is a schematic diagram illustrating the production process of the stator, which follows FIG. 8.

FIG. 10 is a schematic cross-sectional view taken along line A-A of FIG. 9.

FIG. 11 is a schematic cross-sectional view illustrating a rotary electrical machine according to a modification example.

### DESCRIPTION OF EMBODIMENTS

Hereinafter, several embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, expressions such as “being provided with”, “including”, or “having” one component are not exclusive expressions excluding existence of other components. The same configurations are denoted by the same reference numerals, and the description thereof may be omitted.

### Overall Configuration of Electric Compressor Device 10

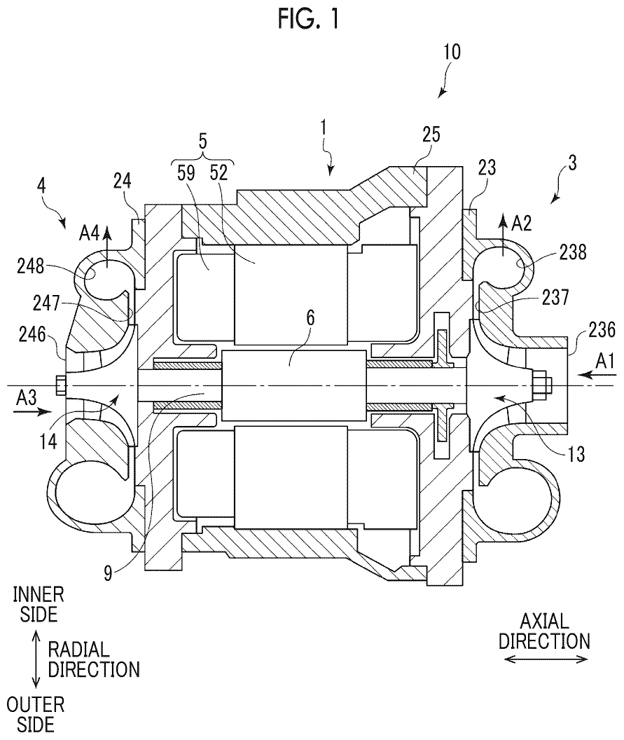

An electric compressor device 10 in which a rotary electrical machine 1 including a rotary shaft 9 is incorporated will be described. FIG. 1 is a schematic cross-sectional view of the electric compressor device 10 according to one embodiment of the present disclosure. The electric compressor device 10 of the present example is a two-stage compression electric compressor, and is configured to send compressed air to a fuel cell mounted on a vehicle.

In the following description, a direction in which an axis of the rotary shaft 9 extends is referred to as an “axial direction”, and a circumferential direction and a radial direction with reference to the axis may be simply referred to as a “circumferential direction” and a “radial direction”. An outer side in the radial direction is a side in a direction away from the axis of the rotary shaft 9, and an inner side in the radial direction is a side in a direction close to the axis.

The rotary electrical machine 1, which is a component of the electric compressor device 10, includes the rotary shaft 9, a rotor 6 fixed to the rotary shaft 9, a stator 5 facing the rotor 6 in the radial direction, and a housing 25 that supports the stator 5. The rotor 6 has a rotor core fixed to a substantially central portion of the rotary shaft 9 and a plurality of permanent magnets supported by the rotor core. The stator 5 includes a stator core 52 and a stator coil 59 provided in the stator core 52 (details of the stator 5 will be described later). The rotor 6 and the stator 5 are accommodated in the housing 25.

The electric compressor device 10 further includes a low-pressure compressor 3 and a high-pressure compressor 4. The low-pressure compressor 3 includes a low-pressure wheel 13 provided at one end portion of the rotary shaft 9, and a low-pressure housing 23 that accommodates the low-pressure wheel 13. The high-pressure compressor 4 includes a high-pressure wheel 14 provided at the other end portion of the rotary shaft 9, and a high-pressure housing 24 that accommodates the high-pressure wheel 14. The low-pressure housing 23 and the high-pressure housing 24 are disposed so as to sandwich the housing 25 of the rotary electrical machine 1 in the axial direction.

The low-pressure housing 23 is formed with an intake port 236, a diffuser 237, a scroll portion 238, and a discharge port (not illustrated). Similarly, the high-pressure housing 24 is formed with an intake port 246, a diffuser 247, a scroll portion 248, and a discharge port (not illustrated). The discharge port of the low-pressure housing 23 is connected to the intake port 246 of the high-pressure housing 24 via a connection pipe (not illustrated).

The rotary electrical machine 1 illustrated in FIG. 1 is configured to function as an electric motor. An operation summary of the electric compressor device 10 is as follows. A rotating magnetic field is formed by the current flowing through the stator coil 59, so that the rotor 6 starts to rotate together with the rotary shaft 9. Accordingly, the low-pressure wheel 13 and the high-pressure wheel 14 also start to rotate. In the low-pressure compressor 3, air is suctioned from the intake port 236 (arrow A1). The suctioned air is accelerated by the centrifugal force of the low-pressure wheel 13, and the accelerated air is decelerated and pressurized by the diffuser 237, and then flows through the scroll portion 238 and is discharged from the discharge port (arrow A2). The low-pressure air compressed by the low-pressure compressor 3 is sent to the intake port 246 via a connection pipe (arrow A3). In the high-pressure compressor 4, the low-pressure air that has passed through the intake port 246 is accelerated by the centrifugal force of the high-pressure wheel 14. After the accelerated air is decelerated and pressurized by the diffuser 247, the air flows through the scroll portion 248 and is discharged from the discharge port (arrow A4).

### Basic Configuration of Stator 5

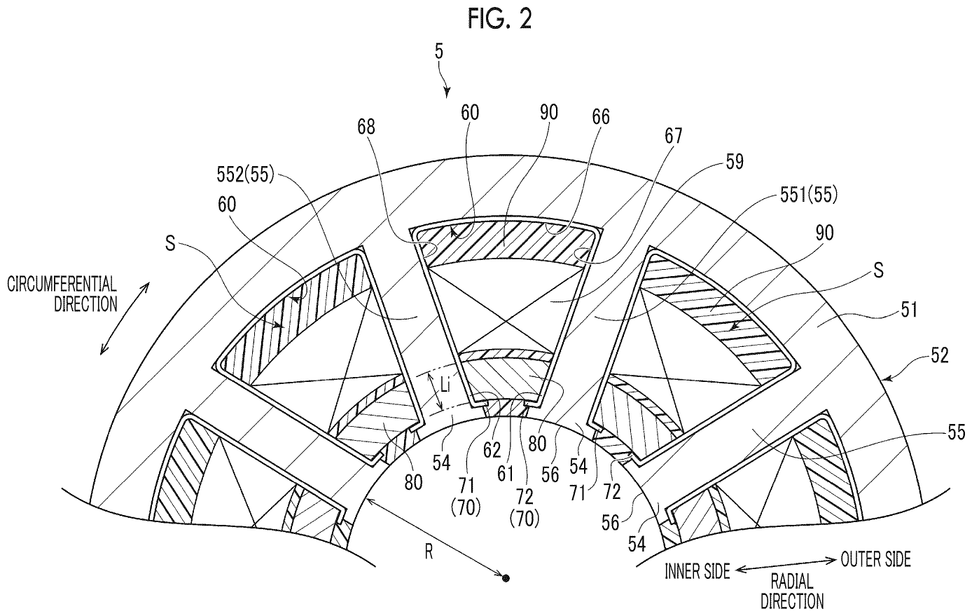

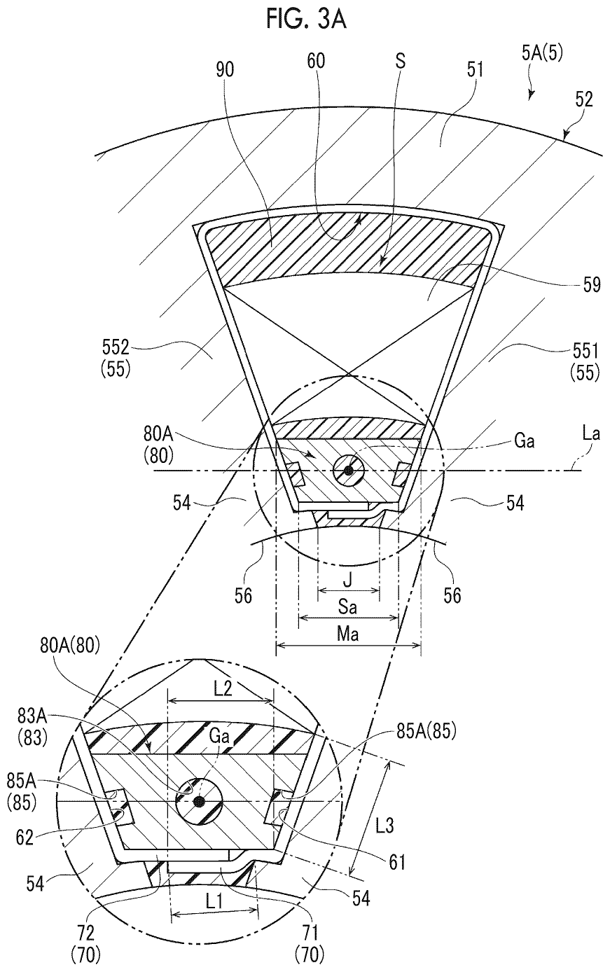

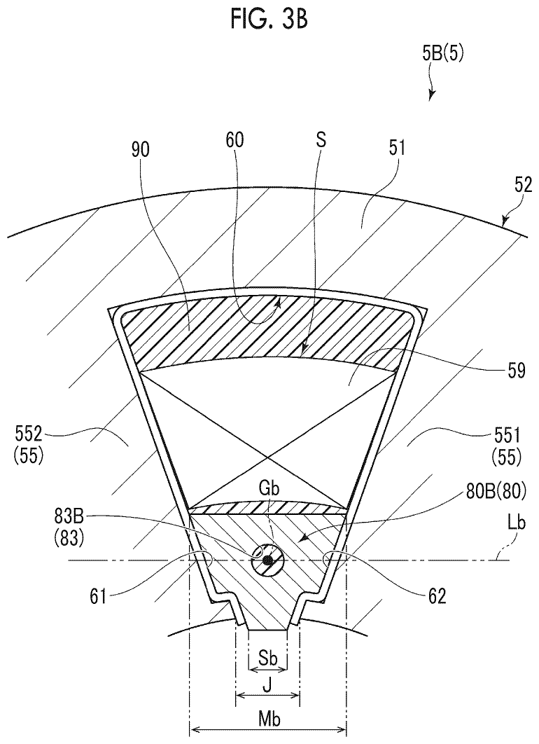

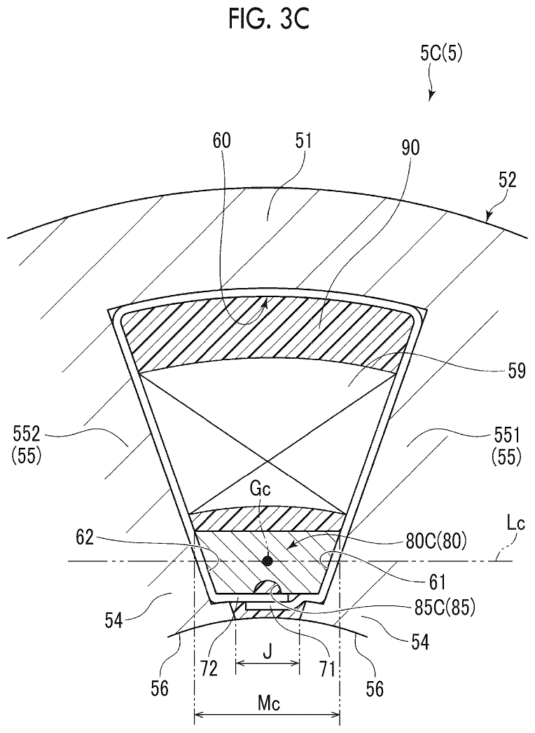

FIG. 2 is a schematic cross-sectional view of the stator 5 according to one embodiment of the present disclosure. The stator core 52 includes a yoke 51 extending in the circumferential direction and a plurality of teeth 55 disposed on the inner peripheral side of the yoke 51. The plurality of teeth 55 are disposed at equal intervals in the circumferential direction and are integrally configured with the yoke 51. The stator coil 59 is disposed between two teeth 55 adjacent to each other in the circumferential direction. In the present example, the stator coil 59 is disposed between any two teeth 55 adjacent to each other among the plurality of teeth 55. A winding method of the stator coil 59 may be either a distributed winding or a concentrated winding, but the distributed winding is illustrated in FIG. 2 (the same applies to FIGS. 3A to 3C and the like).

The stator 5 further includes an insulation sheet 60 disposed between two teeth 55 adjacent to each other in the circumferential direction. The insulation sheet 60 is located inside the inner peripheral surface of the yoke 51 in the radial direction and is interposed between the teeth 55 and the stator coil 59. In the present example, the insulation sheet 60 is disposed between any two teeth 55 adjacent to each other among the plurality of teeth 55. For the sake of making the drawings easier to see, the insulation sheet 60 is not hatched in FIG. 2. In the following, one of two adjacent teeth 55 may be referred to as “the one tooth 551” and the other may be referred to as “the other tooth 552”.

The insulation sheet 60 includes a facing portion 66 facing the inner peripheral surface of the yoke 51. The facing portion 66 faces the inner peripheral surface of the yoke 51 over the entire length of the stator core 52 in the axial direction. The facing portion 66 is in direct contact with the inner peripheral surface of the yoke 51. Further, the insulation sheet 60 includes a first extending portion 67 and a second extending portion 68. The first extending portion 67 and the second extending portion 68 extend toward the inner side in the radial direction from both end portions of the facing portion 66 in the circumferential direction. The first extending portion 67 is interposed between the stator coil 59 and the one tooth 551. The second extending portion 68 is interposed between the stator coil 59 and the other tooth 552. The first extending portion 67 and the second extending portion 68 are in direct contact with the one tooth 551 and the other tooth 552, respectively.

The stator 5 further includes an insulation member 80 extending in the axial direction. The insulation member 80 is disposed between the two teeth 55 adjacent to each other in the circumferential direction and is disposed inside the stator coil 59 in the radial direction. The insulation member 80 is formed of a resin material as an example. In the present example, the insulation member 80 is disposed between any two teeth 55 adjacent to each other among the plurality of teeth 55.

The insulation member 80 is in contact with the one tooth 551 and the other tooth 552 via the first extending portion 67 and the second extending portion 68 of the insulation sheet 60. Hereinafter, portions of the first extending portion 67 and the second extending portion 68 located inside the radial outer end portion of the insulation member 80 may be referred to as a “first interposed portion 61” and a “second interposed portion 62”. The first interposed portion 61 is interposed between the one tooth 551 and the insulation member 80, and the second interposed portion 62 is interposed between the other tooth 552 and the insulation member 80.

According to the above-described configuration, the stator coil 59 can be disposed on the outer side in the radial direction as compared with a case where the insulation member 80 is not disposed between the two adjacent teeth 55, and the insulation sheets 60 are disposed on both sides of the insulation member 80 in the circumferential direction. Accordingly, a creepage distance from the stator core 52 to the stator coil 59 increases, and thus the stator 5 with improved insulation properties is realized.

For example, in the embodiment in which the electric compressor device 10 in which the rotary electrical machine 1 is incorporated is a two-stage compression electric compressor, the voltage in the stator coil 59 tends to be high, and the risk of the stator core 52 and the stator coil 59 being electrically connected to each other tends to increase. In this regard, according to the above-described configuration, it is possible to improve the insulation properties of the stator 5 of the two-stage compression electric compressor.

In addition, when a magnetic flux (not illustrated) that travels between the two adjacent teeth 55 passes through the stator coil 59, an eddy current is generated in the stator coil 59. The magnetic flux tends to be particularly strong at a tip portion 54 of the teeth 55. This is because a distance between the two teeth 55 adjacent to each other becomes smaller toward the inner side in the radial direction. In this regard, according to the above-described configuration, the stator coil 59 is disposed on the outer side in the radial direction. Therefore, it is possible to suppress the generation of eddy currents in the stator coil 59, and it is also possible to reduce the eddy current loss of the stator 5.

Although not an essential component of the present disclosure, the insulation sheet 60 illustrated in FIG. 2 may further include an extension portion 70. The extension portion 70 is connected to at least one of the first interposed portion 61 or the second interposed portion 62, and extends along the circumferential direction inside the insulation member 80 in the radial direction. The extension portion 70 illustrated in FIG. 2 has a first extension portion 71 that is connected to the inner end portion of the first interposed portion 61 in the radial direction and that extends along the circumferential direction, and a second extension portion 72 that is connected to the inner end portion of the second interposed portion 62 in the radial direction and that extends along the circumferential direction. The first extension portion 71 extends toward the second extending portion 68, and the second extension portion 72 extends toward the first extending portion 67.

According to the above-described configuration, the extension portion 70 is provided, so that the creepage distance from the stator core 52 to the stator coil 59 is further increased, and the insulation properties of the stator 5 are further improved. The extension portion 70 may include only the first extension portion 71 or only the second extension portion 72 of the first extension portion 71 or the second extension portion 72. Even in this case, the same technical advantages can be obtained.

In addition, in some embodiments in which the extension portion 70 has the first extension portion 71 and the second extension portion 72, the first extension portion 71 and the second extension portion 72 may face each other in the radial direction (refer to FIG. 3A to be described later). According to the above-described configuration, each of the first extension portion 71 and the second extension portion 72 can be made long to such an extent that the first extension portion 71 and the second extension portion 72 face each other in the radial direction. The creepage distance from the stator core 52 to the stator coil 59 is further increased, so that the insulation properties of the stator 5 are further improved. In FIG. 3A to be described later, the creepage distance from the stator core 52 to the stator coil 59 corresponds to the total value of dimensions L1, L2, and L3.

As illustrated in FIG. 2, each of the tip portions 54 of the plurality of teeth 55 has a tooth inner peripheral surface 56 facing the inner side in the radial direction. The tooth inner peripheral surface 56 is a curved surface extending in the circumferential direction. Although not an essential component of the present disclosure, a radial length (dimension Li) of the insulation member 80 is 5% or more of a curvature radius (dimension R) of the tooth inner peripheral surface 56. As a more detailed example, the dimension Li is 5% or more and 10% or less of the dimension R.

According to the above-described configuration, the stator coil 59 can be disposed on the outer side in the radial direction by increasing the radial length of the insulation member 80. Accordingly, the creepage distance from the stator core 52 to the stator coil 59 is further increased, so that the insulation properties of the stator 5 are further increased.

Although not an essential component of the present disclosure, as illustrated in FIG. 2, the stator 5 may further include a filling portion 90. The filling portion 90 is a thermoplastic resin member that fills a slot space S, which is a space between the two adjacent teeth 55, in the axial direction. The slot space S is a space defined by an end surface of the one tooth 551, an end surface of the other tooth 552, and an inner peripheral surface of the yoke 51. The stator coil 59 is also disposed to be buried in the filling portion 90. More specifically, the stator coil 59 includes a plurality of wire materials that extend in a substantially linear shape in the axial direction along the teeth 55, and at least a part of the plurality of wire materials is covered with the filling portion 90 (detailed illustration is omitted in FIG. 2 as a schematic diagram).

### Insulation Member 80

FIGS. 3A to 3C are schematic cross-sectional views of stators 5A to 5C (5). In the same drawings, maximum width dimensions of insulation members 80A to 80C (80) are represented by dimensions Ma to Mc for the stators 5A to 5C (5). Here, when straight lines passing through the centers of gravity Ga to Gc of the insulation members 80A to 80C while being orthogonal to the radial direction are defined as virtual straight lines La to Lc in the cross section of the stator 5 orthogonal to the axial direction, the width dimension of the insulation members 80A to 80C (80) is the length of the insulation members 80 in the extension direction of the virtual straight lines La to Lc. The width dimension of the insulation member 80 is defined by both ends of the insulation member 80 in the circumferential direction. In addition, in FIGS. 3A to 3C, a shortest tooth distance, which is a shortest distance between two adjacent teeth 55, is indicated by dimension J.

As illustrated in FIGS. 3A to 3C, the maximum value (dimensions Ma to Mc) of the width dimensions of the insulation members 80A to 80C (80) is larger than the shortest tooth distance (dimension J). According to the above-described configuration, the insulation member 80 is less likely to pass between the two teeth 55 adjacent to each other. Therefore, it is possible to prevent the insulation member 80 from falling off the stator core 52.

As illustrated in FIGS. 3A and 3B, the insulation members 80A and 80B (80) have a shape in which the width dimension decreases toward the inner side in the radial direction. The minimum value of the width dimension of the insulation member 80A is indicated by a dimension Sa. The width dimension of the insulation member 80B is indicated by a dimension Sb.

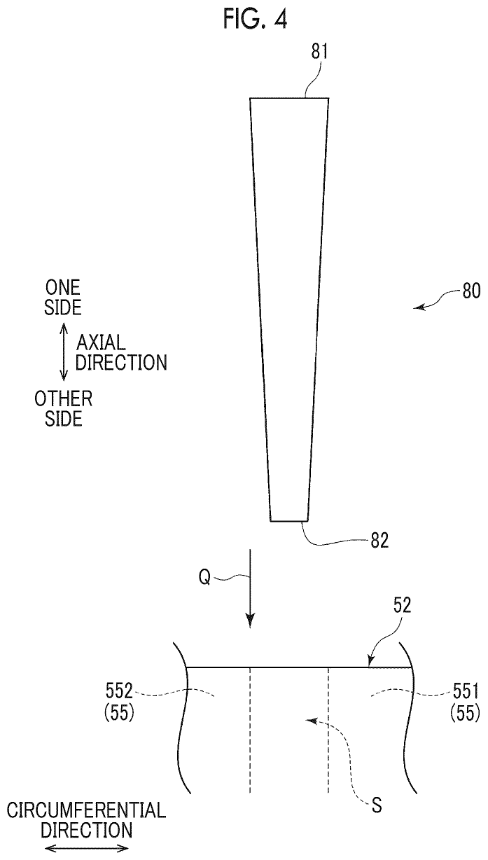

As illustrated in FIGS. 3A to 3C, the insulation members 80A to 80C (80) include at least one of the hole portion 83 or the recessed portion 85 formed from one end portion 81 (refer to FIG. 4) to the other end portion 82 (refer to FIG. 4) in the axial direction. The insulation member 80A includes both the hole portion 83A (83) and the recessed portion 85A (85). The insulation member 80B includes the hole portion 83B (83) but does not include the recessed portion 85. The insulation member 80C includes the recessed portion 85C (85) but does not include the hole portion 83.

The hole portions 83A and 83B (83) penetrate the central portions of the insulation members 80A and 80B (80) when viewed in the axial direction. The hole portion 83 illustrated in FIGS. 3A and 3B has a circular shape when viewed in the axial direction. However, the hole portion 83 according to another example may have a rectangular shape or the like. In addition, the recessed portions 85A and 85C (85) are recesses formed on the outer surfaces of the insulation members 80A and 80C (80). The recessed portion 85A of FIG. 3A is formed on each of one end surface and the other end surface of the insulation member 80A in the circumferential direction, and the recessed portion 85C of FIG. 3C is formed on an inner surface of the insulation member 80C in the radial direction. A technical advantage obtained by providing at least one of the hole portion 83 or the recessed portion 85 in the insulation member 80 will be described later.

FIG. 4 is a schematic diagram of the insulation member 80 according to one embodiment of the present disclosure. As illustrated in the drawing, the insulation member 80 according to some embodiments has a shape in which the width dimension decreases from one side toward the other side in the axial direction. In the example of the drawing, the width dimension of the insulation member 80 continuously decreases from the one end portion 81 to the other end portion 82 of the insulation member 80. A technical advantage obtained by adopting such a configuration will be described later. In the insulation member 80 illustrated in FIG. 4, at least one of the hole portion 83 or the recessed portion 85 described above may be provided or may not be provided.

### Production Method of Stator 5

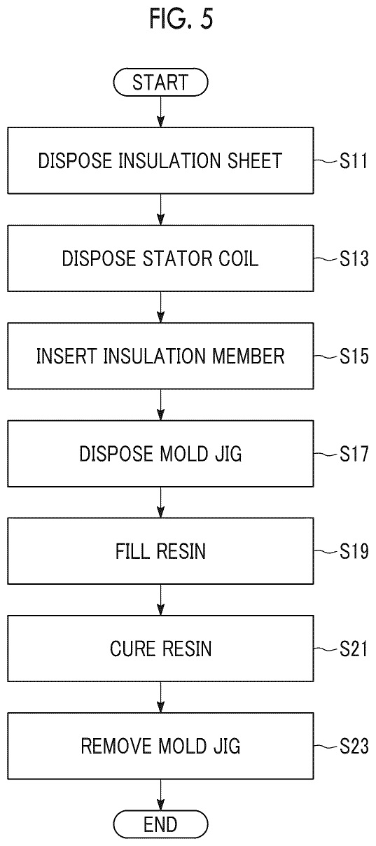

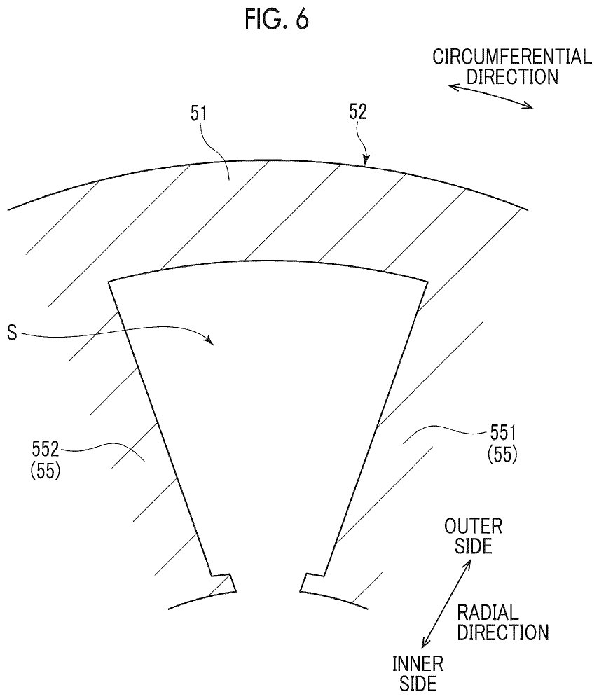

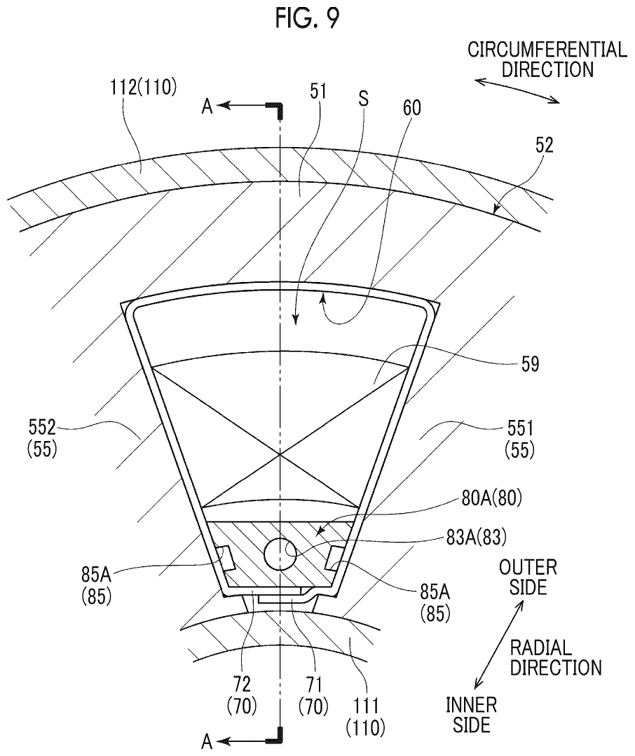

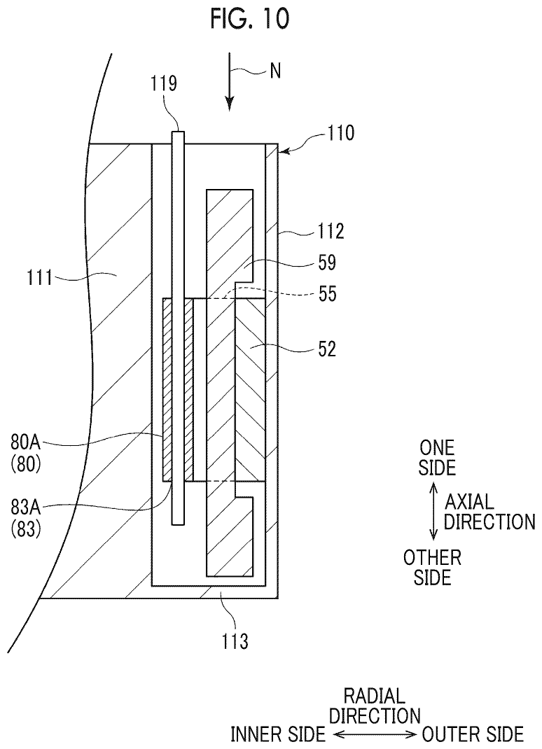

A production method of the stator 5 will be described with reference to FIGS. 5 to 10. FIG. 5 is a flowchart illustrating a production method of the stator 5A(5) according to one embodiment of the present disclosure. FIGS. 6 to 9 are schematic diagrams illustrating a production process of the stator 5A (5). FIG. 10 is a cross-sectional view taken along line A-A of FIG. 9. In FIG. 10, the insulation sheet 60 is not illustrated. In the following, a “step” may be abbreviated as “S”. In addition, it is assumed that the stator 5A is held in a posture in which the axial direction coincides with the vertical direction.

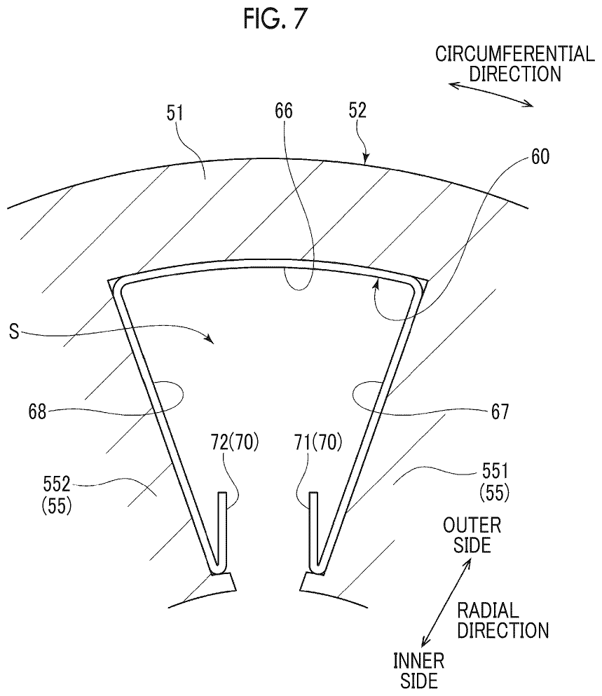

First, an insulation sheet disposition step (S11) of disposing the insulation sheet 60 in the slot space S between the two adjacent teeth 55 forming the stator core 52 is executed. More specifically, as illustrated in FIGS. 6 and 7, the insulation sheet 60 is disposed to face the inner peripheral surface of the yoke 51, the end surface of the one tooth 551 in the circumferential direction, and the end surface of the other tooth 552 in the circumferential direction. In the present example, the insulation sheet 60 is disposed in each of the plurality of slot spaces S. In addition, after the insulation sheet 60 is disposed, a sheet jig (not illustrated) may be used so that the portions of the insulation sheet 60 corresponding to the first extension portion 71 and the second extension portion 72 maintain a posture of extending from the inner side toward the outer side in the radial direction (refer to FIG. 7).

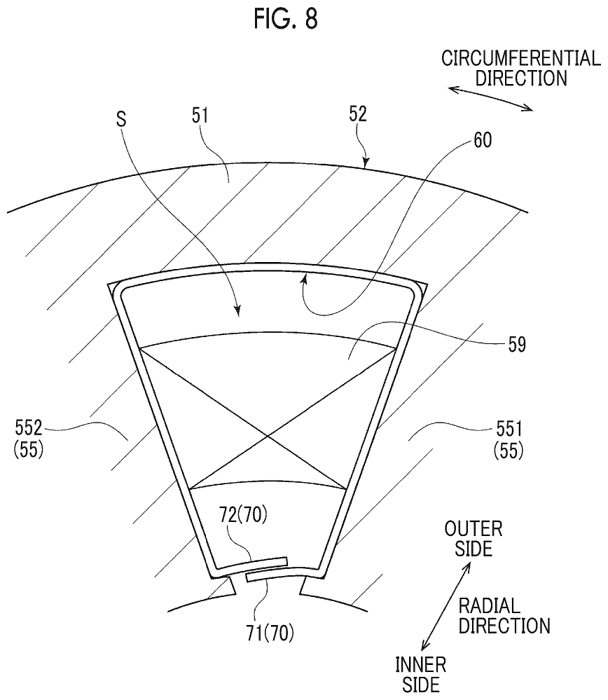

Next, a stator coil disposition step (S13) of disposing the stator coil 59 on the teeth 55 is executed. In the present example, as illustrated in FIG. 8, the stator coil 59 is disposed between the two teeth 55 adjacent to each other in the circumferential direction. As a more specific example, the stator coil 59 may be disposed between the two teeth 55 in a state of being wound in advance. In this case, the stator coil 59 moving from the inner side toward the outer side in the radial direction is less likely to come into contact with the first extension portion 71 and the second extension portion 72, which are maintained in the above-described posture by the sheet jig. Therefore, the disposition of the stator coils 59 can be easily performed. After the stator coil 59 is disposed, the sheet jig is removed. In this manner, the first extension portion 71 and the second extension portion 72 return to the posture of extending in the circumferential direction (refer to FIG. 8).

Next, an insulation member insertion step (S15) of inserting the insulation member 80A (80) into the slot space S is executed. In the present example, the insulation member 80 is slid along the axial direction (arrow Q in FIG. 4) such that the other end portion 82 of the insulation member 80 illustrated in FIG. 4 enters the slot space S before the one end portion 81, and the insulation member 80 is inserted into the slot space S (refer to FIG. 9).

Next, a mold jig disposition step (S17) of disposing a mold jig 110 in the stator core 52 is executed. The mold jig 110 includes an inner jig 111 disposed inside the plurality of teeth 55, an outer jig 112 that covers the outer peripheral surface of the yoke 51, and a connection portion 113 (refer to FIG. 10) that connects one end portion of each of the inner jig 111 and the outer jig 112 in the axial direction. In S17 of the present example, a pipe 119 (refer to FIG. 10) extending in the axial direction is further inserted into each of the hole portions 83A of the plurality of insulation members 80A. The pipe 119 serves to hold the posture of the insulation member 80.

Next, a resin filling step (S19) of flowing the liquid resin member into the slot space S is executed. In the present example, the liquid resin is poured into the slot space S from above (arrow N in FIG. 10). The position where the resin is poured is a position avoiding the insulation member 80 when viewed in the axial direction. The gas such as air present in the slot space S passes through the inner space of the pipe 119 from below to above in the process of the resin being poured, and is discharged from the slot space S. At this time, there is also a gas that passes through the inner space of the recessed portion 85A from below to above and is discharged from the slot space S. It is understood that the inner space of the pipe 119 is included in the inner space of the hole portion 83A.

Subsequently, a resin curing step (S21) of curing the liquid resin member filling the slot space S is performed. In S21, a heating treatment in which the filling resin is heated via the mold jig 110 may be performed. At a timing when the curing of the resin starts, the pipe 119 is removed from the insulation member 80, and thereafter, the resin is completely cured to form the filling portion 90 (refer to FIG. 3A).

Thereafter, a mold jig removing step (S23) of removing the mold jig 110 is performed, and the production method of the stator 5A ends. The above S11 to S23 may be performed by a person or may be performed by a device operated by a person.

According to the configuration in which the insulation member 80 has a shape in which the width dimension decreases from one side toward the other side in the axial direction, when the insulation member insertion step (S15) is executed, the work of inserting the insulation member 80 into the slot space S can be easily performed.

According to the configuration in which the insulation member 80A (80) includes the hole portion 83 and the recessed portion 85, when the resin filling step (S19) is executed, a gas such as air in the slot space S passes through the inner space of the hole portion 83 or the recessed portion 85 and is discharged to the outside. Accordingly, the liquid resin member can be smoothly poured. Even in a case where the insulation member 80 includes only one of the hole portion 83 or the recessed portion 85, the above-described technical advantages can be obtained.

### Modification Examples

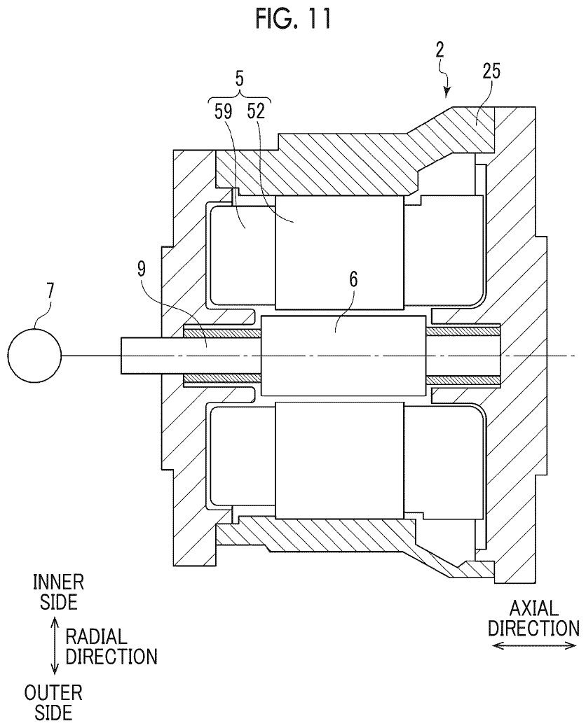

The “rotary electrical machine” of the present disclosure is not limited to an electric motor, and may be a generator. FIG. 11 is a schematic diagram illustrating a rotary electrical machine 2 according to a modification example. The configuration of the rotary electrical machine 2 is the same as that of the rotary electrical machine 1 (refer to FIG. 1), and includes a rotary shaft 9, a rotor 6, a stator 5, and a housing 25. In the rotary electrical machine 2 as a generator illustrated in FIG. 11, the rotary shaft 9 is connected to a prime mover 7. When the rotor 6 rotates as the prime mover 7 rotationally drives the rotary shaft 9, a current is generated in the stator coil 59, and the rotary electrical machine 2 can generate electric power. At least one of the above-described components included in the stator 5 of the rotary electrical machine 1 may be applied to the stator 5 of the rotary electrical machine 2.

### Summary

For example, the content described in some embodiments described above is understood as follows.
1) A stator (5) according to at least one embodiment of the present disclosure includes
a stator core (52) that includes a yoke (51) extending in a circumferential direction and a plurality of teeth (55) disposed on an inner peripheral side of the yoke at intervals in the circumferential direction,
a stator coil (59) disposed between two adjacent teeth,
an insulation sheet (60) disposed between the two adjacent teeth and interposed between the stator core and the stator coil, and
an insulation member (80) disposed between the two adjacent teeth and disposed inside the stator coil in a radial direction,
in which the insulation sheet includes
   a first interposed portion (61) that is interposed between one tooth (551) of two adjacent teeth and the insulation member, and
   a second interposed portion (62) that is interposed between the other tooth (552) of the two adjacent teeth and the insulation member.

According to the configuration of 1), the stator coil can be disposed on the outer side in the radial direction as compared with a case where the insulation member is not disposed between the two teeth, and the insulation sheets are disposed on both sides of the insulation member in the circumferential direction. Accordingly, the creepage distance from the stator core to the stator coil increases, and thus a stator in which the insulation properties are improved is realized. In addition, when the magnetic flux that travels between the two teeth passes through the stator coil, an eddy current is generated in the stator coil. The magnetic flux tends to be particularly strong at the tip portion (54) of the teeth. In this regard, according to the configuration of 1), the stator coil is disposed on the outer side in the radial direction. Therefore, it is possible to suppress the generation of eddy currents in the stator coil, and it is also possible to reduce the eddy current loss of the stator.
2) In some embodiments, in the stator according to 1),
the insulation sheet further includes an extension portion (70) extending along the circumferential direction from at least one of the first interposed portion or the second interposed portion inside the insulation member in the radial direction.

According to the configuration of 2), the creepage distance from the stator core to the stator coil is further increased by providing the extension portion. Therefore, the insulation properties of the stator are further improved.
3) In some embodiments, in the stator according to 2),
the extension portion includes
   a first extension portion (71) that is connected to the first interposed portion and extends along the circumferential direction, and
   a second extension portion (72) that is connected to the second interposed portion and extends along the circumferential direction, and
the first extension portion and the second extension portion face each other in the radial direction.

According to the configuration of 3), each of the first extension portion and the second extension portion can be made longer to such an extent that the first extension portion and the second extension portion face each other in the radial direction. Therefore, the creepage distance from the stator core to the stator coil is further increased. Therefore, the insulation properties of the stator are further improved.
4) In some embodiments, in the stator according to 1) or 3),
each of the plurality of teeth includes a tooth inner peripheral surface (56) facing an inner side in the radial direction, and
a radial length of the insulation member is 5% or more of a curvature radius of the tooth inner peripheral surface.

According to the configuration of 4), the stator coil can be disposed on the outer side in the radial direction by increasing the radial length of the insulation member. Accordingly, the creepage distance from the stator core to the stator coil is further increased, and thus the insulation properties of the stator are further increased.
5) In some embodiments, in the stator according to any one of 1) to 4),
in a cross section the stator orthogonal to an axial direction, a maximum value of a width dimension (Ma, Mb, Mc) of the insulation members is larger than a shortest tooth distance (J) which is a shortest distance between two adjacent teeth, and
the width dimension is a length of the insulation member in an extension direction of a virtual straight line (La, Lb, Lc) passing through a center of gravity (Ga, Gb, Gc) of the insulation member while being orthogonal to the radial direction.

According to the configuration of 5), the insulation member is less likely to pass between the two adjacent teeth. Therefore, it is possible to prevent the insulation member from falling off the stator core.
6) In some embodiments, in the stator according to 5),
the insulation member has a shape in which the width dimension decreases toward an inner side in the radial direction, and
a minimum value (Sa) of the width dimension of the insulation member is larger than the shortest tooth distance.

According to the configuration of 6), the insulation member can be disposed outside the tooth inner peripheral surfaces of the two adjacent teeth in the radial direction. Since the stator coil can be disposed on the outer side in the radial direction, the creepage distance from the stator core to the stator coil is further increased.
7) In some embodiments, in the stator according to any one of 1) to 6),
the insulation member has a shape in which a width dimension (Ma, Mb, Mc) decreases from one side toward the other side in an axial direction, and
the width dimension is a length of the insulation member in an extension direction of a virtual straight line (La, Lb, Lc) passing through a center of gravity (Ga, Gb, Gc) of the insulation member while being orthogonal to the radial direction.

According to the configuration of 7), in the production process of the stator, the step of inserting the insulation member into the slot space can be more easily performed.
8) In some embodiments, in the stator according to any one of 1) to 7),
the stator further includes a filling portion (90) that is a resin member filling a slot space(S), which is a space between the two adjacent teeth, in the axial direction, and
the insulation member includes at least one of a hole portion (83) or a recessed portion (85) formed from one end portion (81) to the other end portion (82) in the axial direction.

According to the configuration of 8), when the liquid resin member is poured into the slot space in the process of producing the stator, the gas such as air in the slot space is discharged from the internal space of the hole portion or the recessed portion. Accordingly, the liquid resin member can be smoothly poured.
9) A rotary electrical machine (1, 2) according to at least one embodiment of the present disclosure includes
the stator (5) according to any one of 1) to 8),
a rotary shaft (9) that is provided inside the stator in the radial direction, and
a rotor (6) that is provided on the rotary shaft and faces the stator in the radial direction.

According to the configuration of 9), the same technical advantages as those of 1) can be obtained.
10) A stator (5) production method according to at least one embodiment of the present disclosure includes
an insulation sheet disposition step (S11) of disposing an insulation sheet in a slot space(S) which is a space between two adjacent teeth included in a stator core,
a stator coil disposition step (S13) of disposing a stator coil on the teeth after executing the insulation sheet disposition step, and
an insulation member insertion step (S15) of inserting an insulation member into the slot space after executing the stator coil disposition step.

According to the configuration of 10), the same technical advantages as those of 1) can be obtained.

11) In some embodiments, in the stator production method according to 10),
the insulation member has a shape in which a width dimension (Ma, Mb, Mc) decreases from one side toward the other side in an axial direction, and
the width dimension is a length of the insulation member in an extension direction of a virtual straight line (La, Lb, Lc) passing through a center of gravity of the insulation member while being orthogonal to the radial direction.

According to the configuration of 11), the same technical advantages as in 7) can be obtained.
12) In some embodiments, in the stator production method according to 10) or 11),
the insulation member includes at least one of a hole portion (83) or a recessed portion (85) formed from one end portion (81) to the other end portion (82) in the axial direction, and
the stator production method further includes
   a resin filling step (S19) of flowing a liquid resin member into the slot space after executing the insulation member insertion step, and
   a resin curing step (S21) of curing the filled resin member.

According to the configuration of 12), the same technical advantages as in 8) can be obtained.

### Reference Signs List

1, 2: Rotary electrical machine
3: Low-pressure compressor
4: High-pressure compressor
5: Stator
6: Rotor
7: Prime mover
9: Rotary shaft
10: Electric compressor device
13: Low-pressure wheel
14: High-pressure wheel
23: Low-pressure housing
24: High-pressure housing
25: Housing
51: Yoke
52: Stator core
54: Tip portion
55: Teeth
56: Tooth inner peripheral surface
59: Stator coil
60: Insulation sheet
61: First interposed portion
62: Second interposed portion
66: Facing portion
67: First extending portion
68: Second extending portion
70: Extension portion
71: First extension portion
72: Second extension portion
80: Insulation member
81: One end portion
82: Other end portion
83: Hole portion
85: Recessed portion
90: Filling portion
110: Mold jig
111: Inner jig
112: Outer jig
113: Connection portion
119: Pipe
Ga to Gc: Center of gravity
J, Li, Ma to Mc, R, Sa: Dimension
La to Lc: Virtual straight line
S: Slot space

1. A stator comprising:
a stator core that includes a yoke extending in a circumferential direction and a plurality of teeth disposed on an inner peripheral side of the yoke at intervals in the circumferential direction;
a stator coil disposed between two adjacent teeth;
an insulation sheet disposed between the two adjacent teeth and interposed between the stator core and the stator coil; and
an insulation member disposed between the two adjacent teeth and disposed inside the stator coil in a radial direction,
wherein the insulation sheet includes
a first interposed portion that is interposed between one of the two adjacent teeth and the insulation member, and
a second interposed portion that is interposed between the other of the two adjacent teeth and the insulation member.

2. The stator according to claim 1,
wherein the insulation sheet further includes an extension portion that is connected to at least one of the first interposed portion or the second interposed portion and extends along the circumferential direction inside the insulation member in the radial direction.

3. The stator according to claim 2,
wherein the extension portion includes
a first extension portion that is connected to the first interposed portion and extends along the circumferential direction, and
a second extension portion that is connected to the second interposed portion and extends along the circumferential direction, and
the first extension portion and the second extension portion face each other in the radial direction.

4. The stator according to claim 1,
wherein each of the plurality of teeth has a tooth inner peripheral surface facing an inner side in the radial direction, and
a radial length of the insulation member is 5% or more of a curvature radius of the tooth inner peripheral surface.

5. The stator according to claim 1,
wherein in a cross section of the stator orthogonal to an axial direction, a maximum value of a width dimension of the insulation member is larger than a shortest tooth distance which is a shortest distance between the two adjacent teeth, and
the width dimension is a length of the insulation member in an extension direction of a virtual straight line passing through a center of gravity of the insulation member while being orthogonal to the radial direction.

6. The stator according to claim 5,
wherein the insulation member has a shape in which the width dimension decreases toward an inner side in the radial direction, and
a minimum value of the width dimension of the insulation member is larger than the shortest tooth distance.

7. The stator according to claim 1,
wherein the insulation member has a shape in which a width dimension decreases from one side toward the other side in an axial direction, and
the width dimension is a length of the insulation member in an extension direction of a virtual straight line passing through a center of gravity of the insulation member while being orthogonal to the radial direction.

8. The stator according to claim 1, further comprising:
a filling portion that is a resin member filling a slot space, which is a space between the two adjacent teeth, in an axial direction,
wherein the insulation member includes at least one of a hole portion or a recessed portion formed from one end portion to the other end portion in the axial direction.

9. A rotary electrical machine comprising:
the stator according to claim 1;
a rotary shaft that is provided inside the stator in the radial direction; and
a rotor that is provided on the rotary shaft and faces the stator in the radial direction.

10. A stator production method comprising:
an insulation sheet disposition step of disposing an insulation sheet in a slot space which is a space between two adjacent teeth included in a stator core;
a stator coil disposition step of disposing a stator coil in the teeth after executing the insulation sheet disposition step; and
an insulation member insertion step of inserting an insulation member into the slot space after executing the stator coil disposition step.

11. The stator production method according to claim 10,
wherein the insulation member has a shape in which a width dimension decreases from one side toward the other side in an axial direction, and
the width dimension is a length of the insulation member in an extension direction of a virtual straight line passing through a center of gravity of the insulation member while being orthogonal to a radial direction.

12. The stator production method according to claim 10,
wherein the insulation member includes at least one of a hole portion or a recessed portion formed from one end portion to the other end portion in an axial direction, and
the stator production method further includes
a resin filling step of flowing a liquid resin member into the slot space after executing the insulation member insertion step, and
a resin curing step of curing the filled resin member.
